(19) United States
(12) Patent Application Publication
(10) Pub. No.: US 2009/0261180 A1
(43) Pub. Date: Oct. 22, 2009

(54) System and Method for Repelling Birds

(76) Inventors: Bruce Donoho, Mission Viejo, CA (US); Rajen Rathod, Bartlett, IL (US)

Correspondence Address: FISH & ASSOCIATES, PC;ROBERT D. FISH, 2603 Main Street, Suite 1000, Irvine, CA, 92614-6232, US

(21) Appl. No.: 12/343,045

(22) Filed: Dec. 23, 2008

Related U.S. Application Data
(63) Continuation-in-part of application No. 12/104,170, filed on Apr. 16, 2008.

(51) Int. Cl. B05B 3/00; A01M 9/00; B05B 7/00

(52) U.S. Cl. 239/69; 239/70; 239/263; 239/226; 239/300

(57) ABSTRACT

A centralized control unit directs compressed air towards repellant dispensers in different repellant locations to distribute atomized bird repellant. The control unit can contain a timer module that controls the time, duration, and recurrence of the mist pulses to optimize bird repellant use. Multiple bird repellant storage tanks can be placed in each repellant dispenser, or a single, common bird repellant storage tank can be used to deliver bird repellant to each repellant dispenser.

### CROSS-REFERENCE TO RELATED APPLICATIONS

This application is a continuation-in-part of application Ser. No. 12/104,170, filed Apr. 16, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is animal repellant atomizers.

### BACKGROUND

It is known in the art to use chemical repellants to ward off animals. Methyl anthranilate, for example, is a naturally occurring GRAS (generally recognized as safe) compound that irritates pain receptors in birds and drives them away.

US 2004/0035879 to Vergote teaches an automated device that atomizes liquid repellants using an air compressor. Vergote, however, is ineffective at distributing a repellant across distances greater than a few meters. If the output of Vergote is increased, the droplets will saturate the air outside the exhaust port, forming larger droplets that will tend to fall to the ground or bind to the surroundings. In order to cover a greater distance, multiple vaporizers must be used.

US 2007/0141098 and U.S. Pat. No. 7,334,745, both to Crawford, teach a dry bird repellant apparatus that creates a haze using a venturi nozzle, and then blows air into the haze to separate the droplets into a “dry bird repellant.” Since the droplet sizes are smaller than with a Vergote system, the dry bird repellant can travel greater distances. However, as the output tube is lengthened, the dry bird repellant particles will tend to adhere to the sides of the tube during travel, and the concentration of bird repellant particles will substantially decrease at greater distances. Additionally, the Crawford devices can not aim the bird repellant towards birds that have moved to a different location around the output tube.

US 2005/0224596 to Panopoulos teaches an automatic animal repellant delivery system with an aimable nozzle. However, Panopoulos requires a separate computer system for each aimable nozzle and repellant tank, which can be rather expensive to operate. Additionally, a remote user controlling the nozzle of Panopoulos does not have any information about environmental features, for example whether or not there is an animal in the vicinity that needs to be repelled.

Thus, there is still a need for an improved repellant vaporizer that can be customized to repel animals in multiple locations depending on environmental features specific to those locations.

### SUMMARY AND PREFERRED EMBODIMENTS

The present invention provides apparatus, systems and methods in which a control device controls an output of repellant dispensers in different repellant locations. The control device could control each repellant dispenser individually or in unison, and preferably has a remote user interface, for example a web site. Control commands could be sent electronically through a hard-wired connection, but are preferably sent wirelessly or through IP over power line to minimize the number of required wires and setup time.

Each repellant dispenser has a nozzle, preferably a venturi nozzle, that dispenses animal repellant into the repellant location that either kills a certain kind of animal, or deters that animal from loitering in that location. Each nozzle could preferably be aimed in different directions, preferably along multiple axes. The nozzles could be mounted on adjustment mechanisms that aim or move the nozzle up or down, from size to side, rotate along a pivot, or any combination thereof. Preferably each dispenser has a base and a mount that rotates up to 360 degrees to control the nozzle's direction.

A preferred animal repellant is one that has methyl anthranilate, but it is contemplated that other insecticides, pesticides, and other animal deterrent compositions could be used. Methyl anthranilate is preferred since it is non-toxic yet has been proven to drive birds away. Since methyl anthranilate is corrosive and tends to plug up or otherwise wear down nozzles, each nozzle is preferably attached to the mount using a spring operated quick-connect that couples the nozzle to the mount. Repellant could be stored in specialized repellant fluid reservoirs with a hose or other fluid passageway that carries repellant fluid from the fluid reservoir to one or more nozzles. When compressed air is blown through the nozzle, some of the fluid repellant is drawn up into the nozzle to atomize into the repellant location. In a preferred embodiment, a low pressure gage pumps air, preferably no more than 15 or 20 psi, into the repellant tank to push liquid repellant through hoses towards the nozzles. A second solenoid valve can be attached to the hose near each nozzle, and attached to the timer. This way, when the timer opens both valves, the released compressed air vaporize the released repellant in a single pulse.

One or more sources of compressed air could be used to vaporize the repellant fluid. Preferably, the source of compressed air is an air compressor that maintains a minimum psi pressure, preferably at least 50, 100, 150, or 200 psi. The air pressure could be maintained, for example, by a regulator that activates the air compressor whenever the psi pressure drops below a threshold, and deactivates the air compressor when the psi pressure exceeds that threshold. A gage could be attached to an output line from the air compressor to control a pressure output from the tank. Multiple gages with multiple output lines could be used, for example a high-pressure gage and a low-pressure gage can be used to create a high-pressure source and a low-pressure source, respectively. A typical air compressor includes an electric or other motor, and at least one compressed air tank.

An airtight seal, preferably a solenoid valve, can be placed along the air passage to control how long and how often compressed air blows through a nozzle. The valve can be normally closed, and only opened when replant needs to be atomized so as not to waste repellant or supersaturate the air by constant atomization. When the system is operating to repel birds, the valve is preferably opened in short pulses over a period of time to create a series of atomizing pulses.

A timer could be connected to a solenoid valve that can designate how long a pulse lasts, the time in between pulses, and when the pulses should occur. For example, a flip-flop timer could designate a given valve to open every 10 minutes for at most 2 seconds, or could designate a series of valves to open for 5 seconds. A scheduling timer attached to the flip-flop timer could designate a phase of operation to be during daylight. Preferably, the timers are controlled by a centralized control device that manages all of the repellant dispensers.

Special sensors could be used to monitor the health of the system, for example the amount of repellant fluid within a repellant reservoir, or to detect environmental features external to the system. As used herein, an “environmental feature” is an attribute of the repellant location that is external to the repellant dispenser. Contemplated environmental features are speed and direction of the wind, temperature, light, noise, vibration, movement of objects, and humidity. A centralized control device connected to the sensors could create reports over a period of time, or could perform an action based upon a threshold trigger. For example, if the amount of repellant fluid drops below 20%, maintenance staff could be notified, or if an animal is detected in the repellant location, a nozzle could be aimed at the animal and animal repellant could be released from the nozzle.

A repellant location is the area that is affected by the atomized repellant to repel the desired animal, for example birds. Preferably, the repellant locations do not substantially overlap, so as to cover a maximum area. Each repellant location area of effect can be increased by blowing air through the venturi nozzle at a higher velocity, which not only spreads the fog farther, but also decreases the droplet size. A “fog” is defined herein to mean distributions in which the mean droplet diameter is no more than 20 μm, although preferred fogs have droplet diameters of no more than 10, 8, 5, or even 3 μm. At 5 μm and below methyl anthranilate is non-allergenic.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a control unit coupled with two repellant dispensers.

FIG. 2 is a schematic of an alternative control unit coupled with two alternative repellant dispensers.

FIG. 3 is a map showing the locations of a control unit and a plurality of repellant dispensers.

FIG. 4 is a schematic of the control unit coupled to a plurality of repellant dispensers and controllable via a remote interface.

FIG. 5 is a plan view of a mount coupled to a repellant dispenser that allows a venture nozzle to be repositioned.

FIGS. 6A and 6B are schematic diagrams of repellant dispenser layouts.

### DETAILED DESCRIPTION

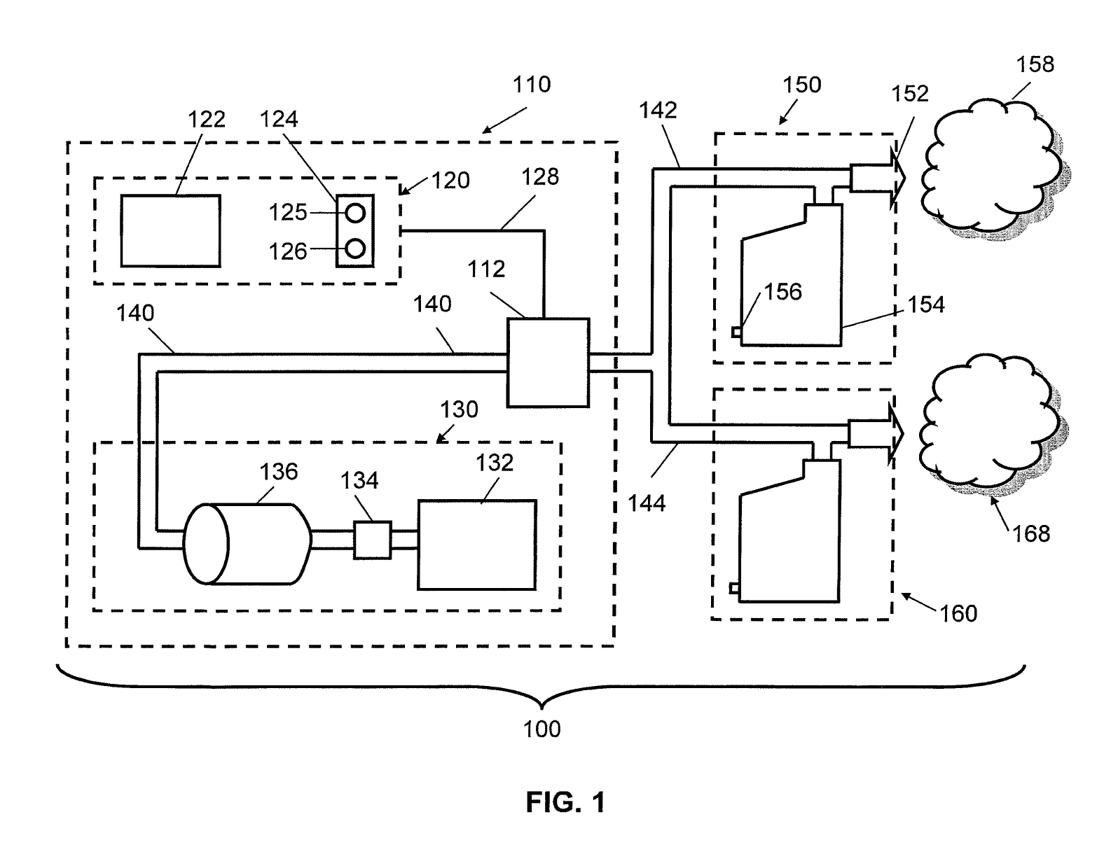

Referring to the drawings to illustrated preferred embodiments, but not for the purpose of limiting the invention, FIG. 1 illustrates a bird repellant sprinkler system 100 generally includes a control unit 110 and multiple repellant dispensers 150 and 160.

Control unit 110 has an air compressor 130, a pressure regulator 134, a solenoid valve 112, and a timer 120.

Air compressor 130 typically has a motor 132, a pressure regulator 134, and a tank 136. Pressure regulator 134 is maintains a minimum pressure in tank 136 preferably using a pressure gage connected to an electronic circuit, although other suitable means can be used. One method of maintaining an air pressure is to turn the motor on when the air pressure in the tank drops below a certain threshold, and to turn the motor off when the air pressure in the tank rises above a certain threshold. The threshold to turn the air compressor off can be different than the threshold to turn the air compressor on. For example, if a user prefers the pressure threshold to be between 100-150 psi, the motor of the air compressor can turn off when the pressure rises above 150 psi and turn on when the pressure drops below 150 psi.

It is contemplated that the air pressure in the air tank can be adjusted as needed. Bird repellant can generally be adequately vaporized using a minimum air pressure of 40 psi. However, since the size of vaporized bird repellant particles can be reduced and the fog dispersion can be increased by increasing the air pressure that is pumped to the nozzles, a higher air pressure is preferred, for example at least 100 psi or 150 psi.

Compressed air is fed to repellant dispensers 150 and 160 through solenoid valve 112. Solenoid valve 112 can be any suitable size and can be made of any suitable material to create an airtight seal between air line 140 and air lines 142 and 144 when closed. When opened, the pressurized air from air line 140 escapes into air lines 142 and 144 to create an atomizing pulse at repellant dispensers 150 and 160. Those skilled in the art will appreciate that the solenoid valve can open a mere gap or can open fully to allow the compressed air to escape.

Timer 120 has a scheduling timer 122 and a flip-flop timer 124 that controls when solenoid valve 112 opens and closes with control wire 128. Scheduling timer 122 designates when the system is active according to a set schedule, for example a certain time of day for a 24-hour timer, or the times of days on various weekdays for a weekly timer. If a user wanted to set the system to repel birds during business hours, the user could set the system to turn on during the hours of 8 AM-6 PM on weekdays. Or, if the user wants to prevent the birds from “learning” the system schedule, the user can set the scheduling timer to randomize the activation time of the system. In general, it is considered advantageous to release pulses of fog during daylight and twilight hours, and prevent such release during night time hours. Although, in some situations, such as when protecting the rooftop of an evening ballgame, repelling birds during night time hours is preferred.

Flip-flop timer 124 controls how long the solenoid valve is opened and closed. In the current embodiment, knob 125 controls how long the solenoid valve remains open in seconds, and knob 126 controls how long the solenoid valve remains closed in minutes. For example, if knob 125 was set to 2 and knob 126 was set to 10, the solenoid valve would remain open for 2 seconds, and then would remain closed for 10 minutes before opening again for 2 seconds. While the current embodiment of flip-flop timer 124 was chosen for simplicity, it is appreciated that alternative flip-flop timer configurations are also suitable.

Repellant dispenser 150 generally comprises a venturi nozzle 152 and a repellant tank 154. Pressurized air from air line 140 withdraws a small amount of repellant from the repellant tank 154 and shoots it through venturi nozzle 152 to create repellant fog 158. A tube (not shown) can be inserted into repellant tank 154 to help draw liquid from the bottom of the tank, and a filter (not shown) can be used to prevent larger droplets from escaping. Repellant tank 154 could be made of any suitable material and could hold any liquid, solid, or gas repellant that vaporizes or otherwise atomizes using a venturi nozzle, but preferably holds a liquid form of methyl anthranilate.

Alarm 156 is attached to repellant tank 154 to detect the amount of repellant left in the tank, and to activate when the level in the tank drops below a certain threshold. Alarm 156 is preferably configured to notify maintenance staff that the volume of repellant is low and the tank needs to be replaced or refilled. Alarm 156 can notify maintenance staff using any suitable method, for example a sonic beep, a blinking light, or an electronic signal sent to a central office. Preferably, alarm 156 could even automatically draw repellant from a central storage unit and automatically refill the tank. Still further, the repellant tank can include a window that allows a user to visually inspect the repellant level.

Repellant dispenser 160 is identical to repellant dispenser 150, except repellant dispenser 160 receives pulses of air through air line 144, and distributes repellant fog 168 to a separate repellant location. It is appreciated that while repellant dispenser 160 is identical to repellant dispenser 150 to reduce complexity of the specification, the repellant dispensers can be different from one another.

It is also appreciated that while solenoid valve is preferably located in control unit 110 as shown, multiple solenoid valves can be attached to an input of the venturi nozzles 152, with multiple wires running from timer 120 to control each solenoid valve. In such an embodiment, the solenoid valves could be opened simultaneously, one at a time, or any combination thereof.

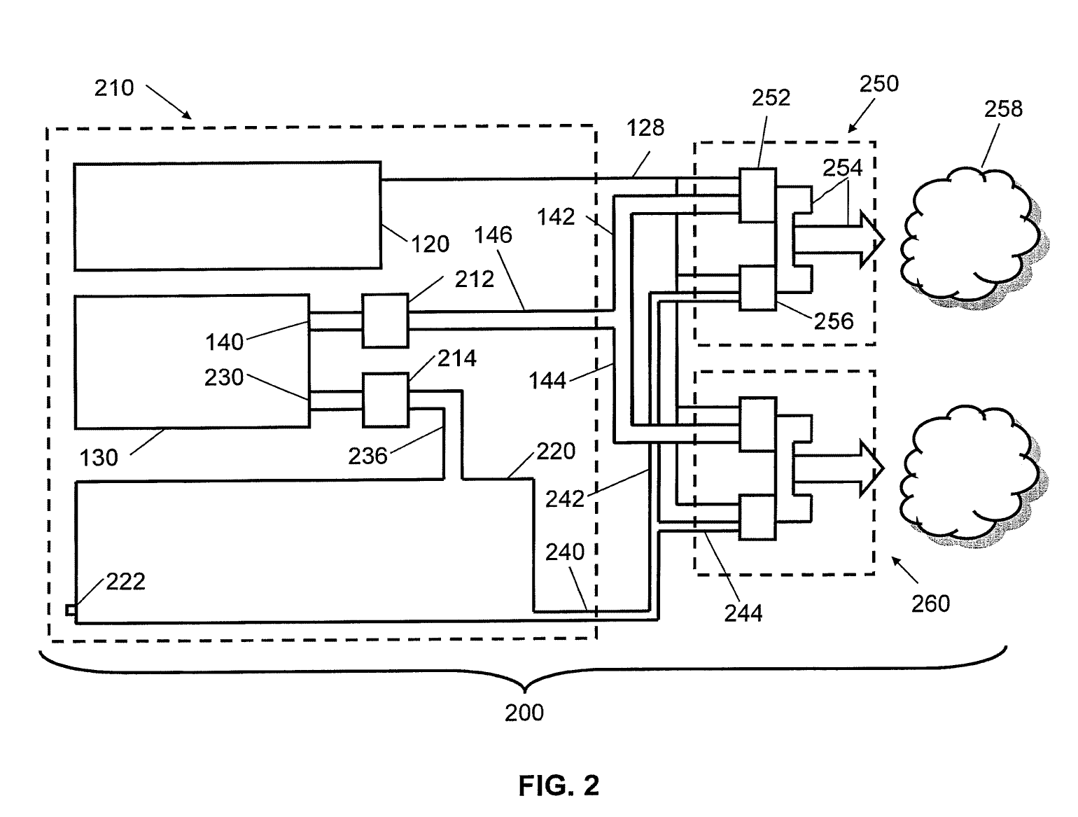

FIG. 2 shows an alternative embodiment of a repellant sprinkler 200 generally including a control unit 210 coupled with repellant dispensers 250, 260.

In this embodiment, a single repellant tank 220 supplies repellant to multiple repellant dispensers 250, 260. Two air lines 140, 230 are used to supply high pressure air to repellant dispensers 250, 260 and low pressure air to bird repellant tank 220, respectively. A high pressure gage 212 is coupled to air line 140 to control a high pressure output to air line 146 while a low pressure gage 214 is coupled to air line 230 to control a low pressure output to air line 236. Pressure gages 212 and 214 can control the pressure output by constricting and expanding a valve. Preferably, high pressure gage 212 restricts the output pressure into air line 146 to a maximum of 150 psi, and low pressure gage 214 restricts the output pressure into air line 236 to a maximum of 15 psi. A person of ordinary skill in the art can appreciate that a variety of pressures can be used without departing from the scope of the invention.

The low pressure air from air line 236 applies pressure to the bird repellant (not shown) in bird repellant tank 220 to push the liquid into fog lines 240, 242, and 244 and to repellant dispensers 250, 260. This is an advantageous method of using a single air compressor to deliver both compressed air and bird repellant to repellant dispensers located in remote locations and/or high altitudes.

Repellant tank 220 has an alarm 222 similar to alarm 156, which can notify maintenance staff that the volume of repellant is low. Since the current embodiment only has one repellant tank, the maintenance staff does not need to check each repellant dispenser to refill the tank. This is ideal when the repellant dispensers are placed in locations that are difficult to maintain, for example the side of a building or the top of a lamp post. Since some repellants, for example methyl anthranilate, is corrosive to plastic, it is preferred that repellant tank 220 can be made of polypropylene or other suitable materials.

While control unit 210 is shown as one unit, and is preferably one unit for maintenance purposes, control unit 210 can be divided into multiple units without departing from the scope of the invention. Repellant tank 220 can be maintained separately so as not to damage timer 120 or air compressor 130. Additionally, timer 120 can be placed on an outside of control unit 210 for ease of accessibility.

Repellant dispenser 250 receives pressurized air from air lines 142 and pressurized bird repellant in fog line 242 which are both fed into venturi nozzle 254. Valve 252 and valve 256 are controlled by timer 120, which opens the valves according to a set schedule. When valve 252 and valve 256 are opened, the pressurized air from air line 142 withdraws a small amount of bird repellant from line 146 and vaporizes it through venturi nozzle 254 to create repellant fog 258. Preferably, all valves are opened and closed simultaneously, but timer 120 can control each valve individually and independently from one another.

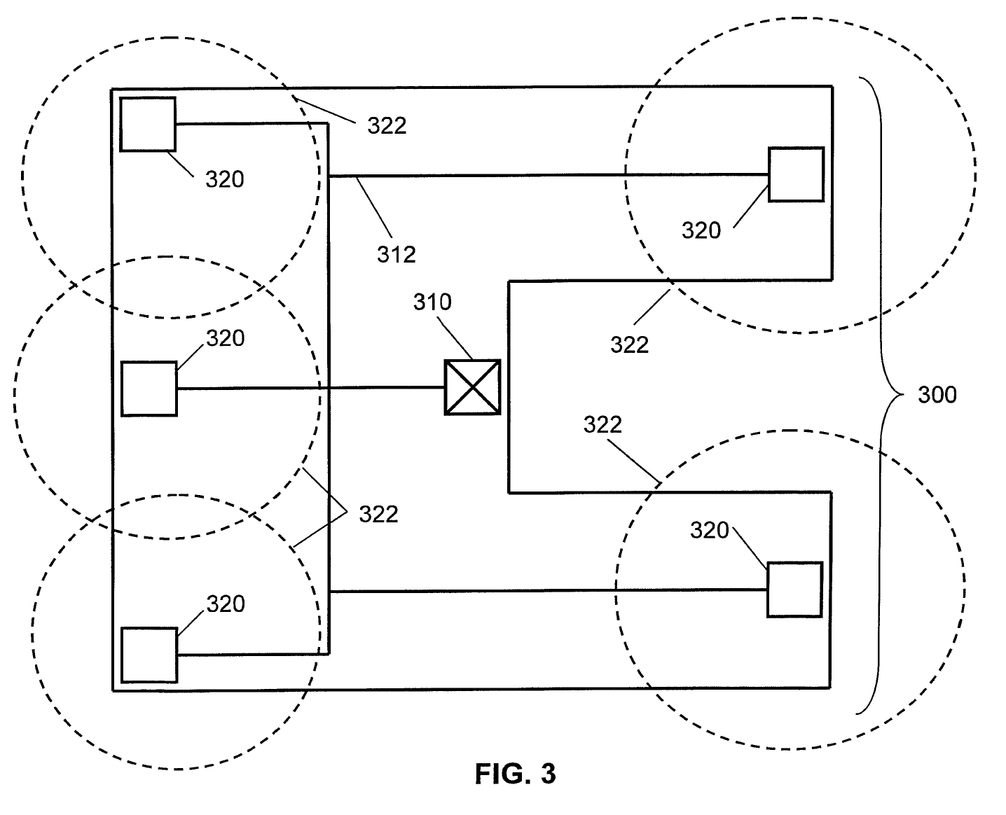

In FIG. 3, a repellant sprinkler system on building 300 repels animals, for example birds, from repellant locations 322 using control unit 310 and repellant dispensers 320.

Control unit 310 remotely activates repellant dispensers 320 from a central location. Each repellant dispenser 320 is capable of generating a fog of repellant, generally a composition comprising methyl anthranilate, which covers a repellant location 322. The shape, size, and volume of repellant locations are dependent on environmental considerations, for example the speed and direction of wind or the orientation of the vaporizing nozzle (not shown). While repellant locations may overlap, minimal overlap is preferred so as to maximize the effective area of the repellant. The repellant dispensers 320 can be connected via a wire 312 or remotely. The repellant locations are preferably at least five meters away from each other, and are more preferably at least fifteen or twenty meters away from one another to prevent any overlap whatsoever.

Separating the repellant dispensers from each other and the control unit by a significant distance reduces the amount of methyl anthranilate residue, which can have a detrimental effect on equipment since methyl anthranilate in its liquid form is relatively caustic. For that same reason, it is preferred that the fog is produced in short vapor pulses to prevent the air from being supersaturated with vaporized repellant, which could coagulate into large droplets that form a residue on the surfaces that contact the droplets. Additionally size of the droplets can be reduced and the fog dispersion can be increased by increasing the air pressure that is pumped to the nozzles.

Using a single control unit 310 is also advantageous as it significantly reduces the cost of the equipment, since the most expensive components are generally the air compressor and timing mechanisms. Instead of purchasing five air compressors and five timing mechanisms to cover five areas, a single air compressor can be used to deliver fog repellant in five different locations, and a single timer can be used to administer five repellant dispensers.

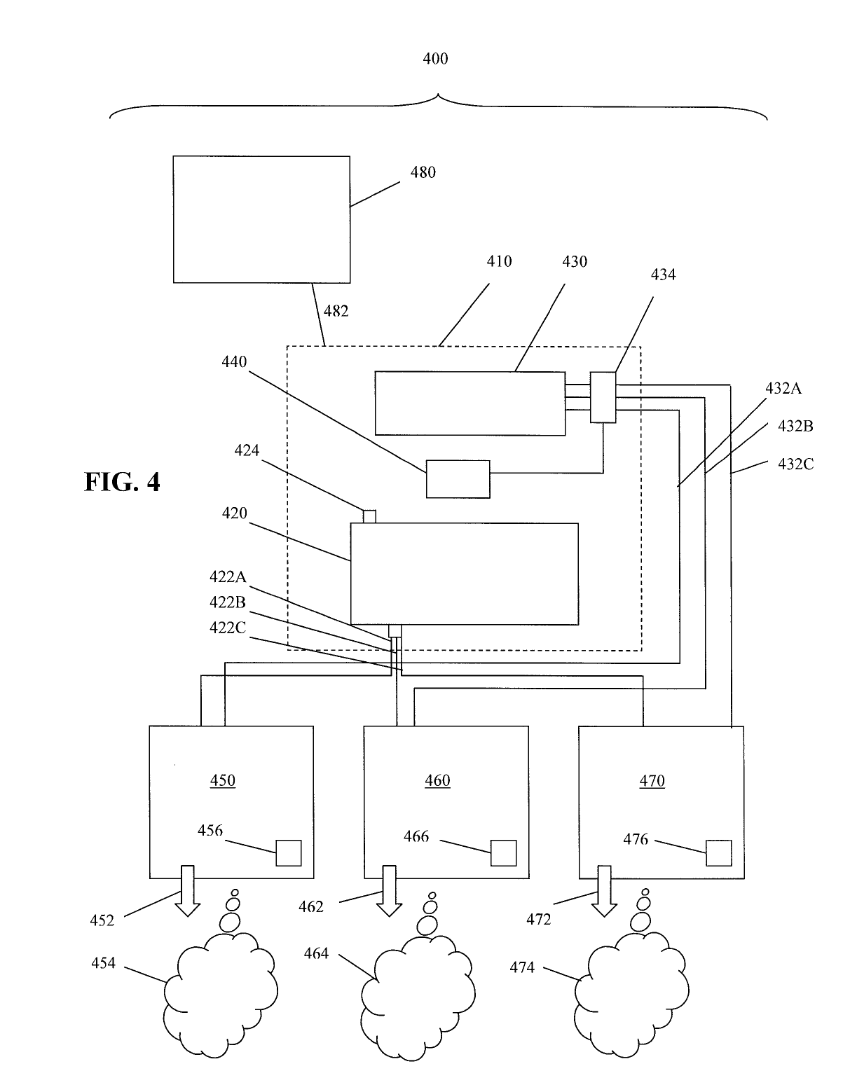

FIG. 4 shows an alternative repellant system 400 that generally comprises a control unit 410, repellant dispensers 450, 460, 470 and a remote interface 480 for remotely controlling repellant system 400 via the web, or another suitable remote system link.

Control unit 410 generally comprises a repellant reservoir 420, air compressor 430, and electronics 440 that regulate air flow to repellant dispensers 450, 460, and 470 via air lines 432A, 432B, and 432C, respectively. Repellant tank 420 is depicted as having fluid lines 422A, 422B, and 422C that supply repellant dispensers 450, 460, 470 respectively, with an animal deterrent. Still further, it is contemplated that the deterrent system 400 can use an animal deterrent concentrate, in which case a separate water reservoir and water lines (not shown) are used to mix the concentrate with water to give rise to an animal deterrent of desired strength.

FIG. 4 depicts control unit 410 housing a single repellant tank 420 and air compressor 430, but it is contemplated that repellant tank 420 and air compressor 430 can be maintained in separate locations, for example within or adjacent to a repellant dispenser, and also that multiple repellant tanks and air compressors can be utilized separately with each repellant dispenser, without departing from the scope of the invention.

Repellant dispensers 450, 460 and 470 generally comprise dispensing nozzles 452, 462 and 472, and environmental sensors 456, 466, and 476 that detect environmental stimulus external to the system. It is contemplated that sensors 456, 466 and 476 could function to detect environmental features, for example ambient light, temperature, noise, vibration, wind direction, wind strength, and motion. Preferably, the motion sensor could be configured to differentiate motion between a human and an animal, for example by using a CCD to recognize an image of a bird, or radar that recognizes a small rodent. In an exemplary embodiment, the sensors monitor the same environmental stimuli over a large area, and report a direction and/or location of environmental stimuli.

Environmental sensors 456, 466, and 476 could provide information to a control unit or a user interface in repellant dispensers 450, 460, and 470, respectively, or could provide information to control unit 410 via a feedback loop (not shown). This information could then be used to control system 400 itself. For example, when a sensor reports that temperature has dropped significantly, the control unit could raise the air pressure flowing to the nozzles to compensate for the thinner air. If wind is blowing in a northerly direction, the control unit could aim the nozzle towards the north to prevent repellant from coating the repellant dispenser. If the sensor detects a large group of birds, the nozzle could be aimed towards the birds to spray repellant, and an air pressure could be increased/decreased depending on how far the birds are from the dispenser. Sensor information could also be aggregated into reports that show the system's efficacy or show trends in animal movement around the sensor that could be used to create optimized schedules.

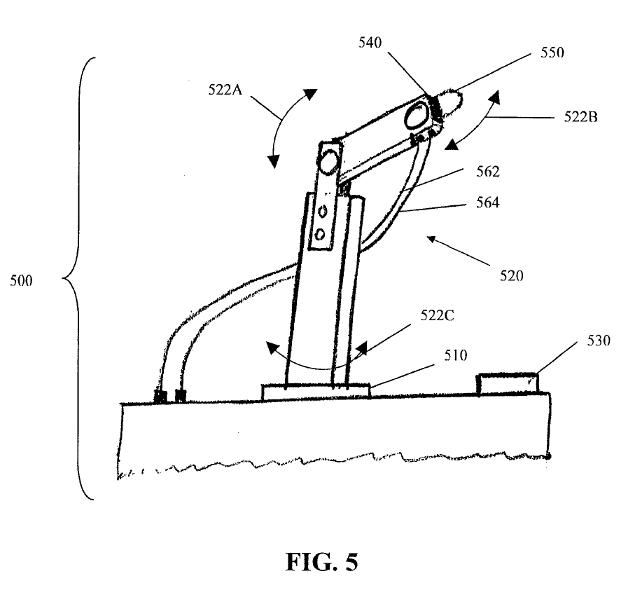

FIG. 5 depicts a preferred repellant dispenser 500 having a mount 520 (e.g. moveable arm) coupled to a base 510 for controlling the positioning of nozzle 550 in three dimensions. Preferred mount 520 is controlled via motor(s) (not shown) that allow nozzle 550 to be moved up and down (as shown by arrows 522A and 522B), side to side (as shown by arrow 522C), and even rotation of the mount 360 degrees. While mount 520 is shown as a moveable arm that aims the nozzle in a direction via two pivot points, mount 520 could be shaped in any suitable manner to aim nozzle 520. For example, mount 520 could have more than two pivot points, or could be mounted on a round ball that moves along multiple axis. As shown, nozzle 550 is coupled to mount 520 via a nozzle mount 540 that can be a spring operated quick-connect mechanism, a snap fitting, or other suitable mechanism that allows a user to easily replace nozzle 550 without the use of tools. Quick-connect mechanisms could also be used to couple the mount to the base.

Nozzle 550 is coupled to air line 562 and bird repellant supply line 564. Preferably, the nozzle is a venturi nozzle, although other atomizing devices could be used without departing from the scope of the present invention. For example, a bubbler could be used that aerates a liquid repellant, or a small amount of heat could be applied to a liquid repellant to evaporate the repellant.

As shown in FIG. 4, remote user interface 480 could be used to remotely manage control unit 410 via a remote connection 482, including for example an Ethernet connection, Bluetooth, WLAN, and other suitable remote connections. Preferably user interface 480 is a web interface that is accessible via a local intranet or the Internet.

It is contemplated that user interface 480 allows a user to control and customize various settings of the repellant system remotely, such as: (1) three dimensional positioning of the nozzle direction via the mount shown in FIG. 5; (2) pressure settings that regulate the droplet size depending on certain conditions; (3) alarm settings related to the repellant level which can also include automatic email warnings, text messages, or other suitable notifications to support staff that the repellant level is low; (4) temperature settings that allow a user to set temperature thresholds for increasing or decreasing droplet size; (5) winding settings that allow a user to customize the droplet size according to the wind strength and direction; (6) timer settings that allow a user to control when the repellant system turns on and off, and also the duration and frequency of the repellant bursts from the nozzles; (7) motion settings that allow a user to configure the system to turn on when a bird or other animal is detected. Preferably, a user could use remote interface 480 to operate repellant dispensers 450, 460 and 470 in unison, individually, sequentially, in parallel, or in any other suitable manner. Thus, the remote user interface 480 via control unit 410 allows a user to completely customize repellant system to follow a customized schedule or to react to customized thresholds that are unique to a particular environment.

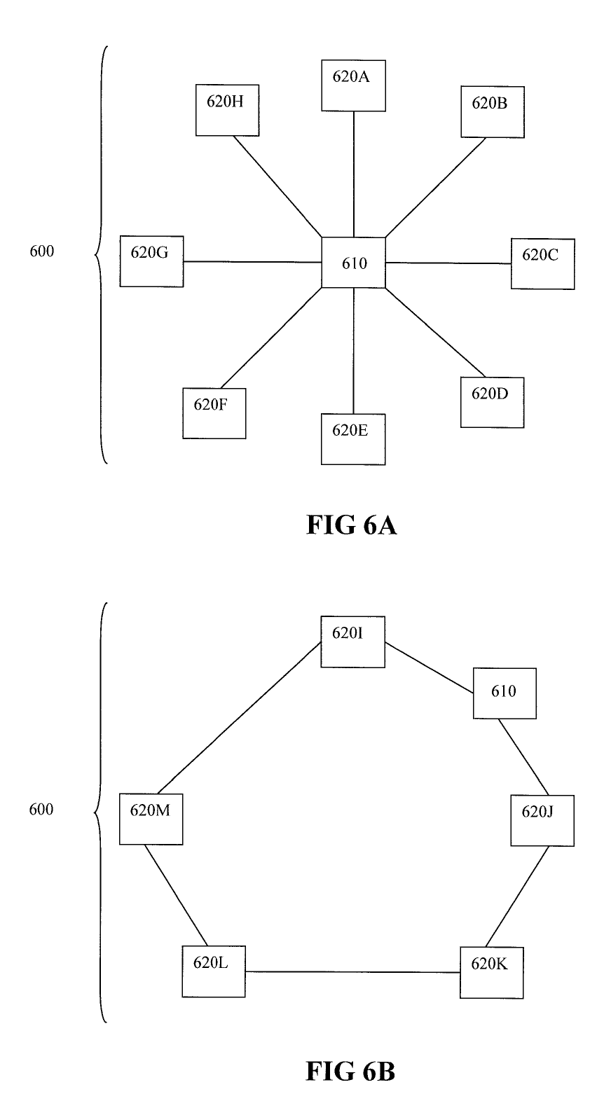

FIGS. 6A and 6B generally depict a bird deterrent system 600 having a central control unit 610 and a plurality of repellant dispensers arranged in: (1) a star configuration (FIG. 6A, numerals 620A-H), and (2) a circle configuration (FIG. 6B, numerals 620I-M). FIGS. 6A and 6B depict potential configurations of the repellant dispensers, but it is contemplated that many other suitable physical arrangements of the repellant dispensers are possible, depending on the needs sand wants of the user.

Thus, specific embodiments and applications of atomizing repellant fog in multiple areas from a central location have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An animal repellant system, comprising:
a first repellant dispenser having a first nozzle;
a second repellant dispenser having a second nozzle; and
a control device disposed to electronically control output of both the first and second repellant dispensers.

2. The system of claim 1, further comprising a mount that allows the first nozzle to move up and down.

3. The system of claim 1, further comprising a mount that allows the first nozzle to move side to side.

4. The system of claim 3, wherein first dispenser has a base and a mount rotatably disposed on the base, rotatable up to 360 degrees.

5. The system of claim 1, further comprising a nozzle mount, and a spring operated quick-connect that couples the first nozzle to the nozzle mount.

6. The system of claim 1, further comprising:
a repellant fluid reservoir; and
a first fluid passageway that carries a first amount of fluid from the fluid reservoir to the first nozzle.

7. The system of claim 6, further comprising a second fluid passageway that carries a second amount of the fluid from the fluid reservoir to the second repellant nozzle.

8. The system of claim 6, further comprising a sensor that detects an amount of repellant fluid within the repellant fluid reservoir.

9. The system of claim 1, further comprising a sensor that detects an environmental feature external to the system.

10. The system of claim 9, wherein the control system sends a signal to aim the first nozzle.

11. The system of claim 1, further comprising:
an air compressor; and
a first air passageway that couples the air compressor with the first repellant dispenser.

12. The system of claim 11, further comprising a second air passageway that couples the air compressor with the second repellant dispenser.

13. The system of claim 11, further comprising an air valve coupled to the first air passageway that controls flow of a gas to the first air passageway.

14. The system of claim 13, wherein the control system has electronics that controls the air valve.

15. The system of claim 14, wherein the control system opens the air valve based upon a timing schedule.

16. The system of claim 1, further comprising an air valve provides bursts of air to the first nozzle.

17. The system of claim 1, further comprising a polypropylene reservoir that supplies a repellant to the first nozzle.

18. The system of claim 1, further comprising a remote user interface that manages the control device.

19. The system of claim 18, wherein the remote user interface comprises a web interface.
